(19) United States
(12) Patent Application Publication
(10) Pub. No.: US 2003/0094355 A1
(43) Pub. Date: May 22, 2003

(54) Switch cover

(76) Inventor: Jan Angst, Hombrechtikon (CH)

Correspondence Address: PEARNE & GORDON LLP, 526 SUPERIOR AVENUE EAST, SUITE 1200, CLEVELAND, OH, 44114-1484, US

(21) Appl. No.: 09/990,168

(22) Filed: Nov. 21, 2001

(51) Int. Cl. H01H 9/04

(52) U.S. Cl. 200/302.1

(57) ABSTRACT

A device to cover one or more switch elements (7) that can be activated by pressure and/or contact to prevent it from becoming dirty and moisture from penetrating inside, etc. has a cover (1) of at least one housing part (3) and at least one cover area (5). The cover is available by means of ZK or multicomponent injection-molding technology. The housing part (3) is preferably made of a dimensionally stable, thermoplastic or partly crosslinked duroplastic polymer, while the cover area or areas is (are) made of a flexible or elastic polymer.

This invention concerns a device for covering one or more switch elements that can be activated by pressure and/or contact to prevent them from becoming dirty and to prevent moisture from penetrating inside, etc., a process for producing a cover and a hearing aid with protected waterproof switch elements, as well as the use of the process to produce a waterproof hearing aid.

It is important that organs such as switches, keys, pads and the like that can be activated by means of pressure or contact can have direct contact or be accessible. Depending on the type, these keys or switches may be levers, buttons, so-called toggles, touch pads, etc. which are usually placed in or on a housing, but are not part of the housing.

Since the switch elements are not part of the housing, there is a risk that places are not tight and contact surfaces are accessible. If the housing must be absolutely waterproof, or there is a risk that the switch elements will become dirty or corroded, which can cause malfunctions and defects in the switch and hearing aid, it is essential that the switch elements be protected accordingly.

The so-called explosion-protected switch housing in manufacturing facilities is known in this connection, for example, where sparks produced by switch elements may not get into the space where the corresponding switch housing is located. These types of devices generally have a flexible cover hood, which are [sic] attached to the housing in the area where the switch or switches are placed. Especially with small devices, such as hearing aids, where explosion protection is not foremost, but waterproofing and preventing dirt are, these types of flexible covers are impractical and are not suited for the manufacturing methods used to produce these types of tiny devices.

The problem of this invention is therefore to create housings for switch elements that do not have the disadvantages mentioned above and that guarantee waterproof, dirt-free protection of the switch elements in the housing.

The invention solves this problem with a device according to the wording of claim 1 and a process according to the wording of claim 7.

The invention proposes that a cover made of at least one housing part and at least one cover area be used to cover one or more switch elements that can be activated by pressure and/or contact to prevent dirt or moisture from getting inside, etc., whereby the cover is available by means of ZK or multi-component injection molding and/or deep-drawing technology.

Using so-called ZK or multicomponent injection-molding or deep-drawing technology, it is proposed that in one and the same production step, two or more polymer materials be injected into a tool at the same time by means of injection-molding technology, to produce an injection-molded part. For this, it is possible to use polymers with different hardnesses or flexibility, which can help solve the problem mentioned at the beginning, insofar as, for example, the housing part or parts of the cover can be made of a polymer material with high dimensional stability, while the cover area or areas can be produced from a polymer material which is flexible or elastic.

Conventional switch elements can be protected using so-called ZK or multicomponent injection-molding technology. Parts like the cover areas mentioned can be designed flexibly in rigid or dimensionally stable housings with ZK technology and used as switch surfaces. The type of switch, key, touch pad, etc. placed under the cover area can vary. The core of the invention is to use at least one of the ZK parts or a flexible or elastic cover area in the housing as the switch surface.

Naturally, it is essential that there be good tolerance and adhesion between the two or more polymer materials used, so even when there are mechanical stresses, no loosening can occur at the borders between the two or more polymer materials. Of course, it is also possible to increase the adhesion on the contact surfaces mentioned even more by structural measures, such as making notched or overlapping connections, etc.

The choice of polymer is also important, whereby besides the adhesion mentioned, requirements like good aging and weather-resistance, good acid and hot water resistance, good UV resistance and, if necessary, other good oil and chemical resistance can be crucial. The requirements mentioned naturally represent only a sample catalogue of requirements, and other requirements can be essential in selecting the polymer materials used.

Most known polymers are suitable as dimensionally stable polymers for making the housing part, such as polyethylenes, polyamides, EVA, ABS, etc., while elastomer polymers are suited for making the flexible cover area, like for example ethylene propylene rubber elastomers, polyamide elastomers, flour-rubber polymers, butyl-rubber polymers, styrene butadiene rubber polymers, SEBS (styrene-ethylene-butylene-styrene elastomers), etc. The above-mentioned list of diverse polymers also contains only examples, and the polymer used is ultimately based on the demands made on the polymers.

Interesting applications of the problem posed by the invention are found especially in the production of tiny devices, where it is not convenient to add a housing part and a flexible cover for cost reasons, for example, in manufacturing. The production of a hearing aid is mentioned as an example, where the reliability and durability of switches generally leaves something to be desired. The perfect functioning of switches is affected in particular by sweat if they are not sealed perfectly and waterproof. This can easily caused dissatisfaction to users or wearers. The cover proposed in the invention makes switching possible without open contact surfaces and directly accessible mechanical switch elements, whereby the dirt problem mentioned can be solved. Another advantage is that switches or keys are generally completely maintenance-free and hence also sturdy. The construction of a waterproof hearing aid can be enhanced by means of the device specified in the invention.

The invention also proposes a process for producing the device described in the invention, where at least two different polymer materials, preferably having different hardness, elasticity or flexibility are processed by means of so-called ZK or multicomponent injection-molding technology.

Multi-component injection-molding technology is well known and need not be described in greater detail here. For example, please refer to the article “Das Mehrkomponenten-Spritzgiessverfahren” [Multicomponent Injection-molding Technology] in Swissplastic 19 (1997) edition No. 12 by Doctor of Engineering Christoph Jaroschek. The choice of polymer used can be essential in this invention, since at least two polymers with different dimensional stability and elasticity must be chosen for the device proposed by the invention. To produce the housing, a polymer with high dimensional stability must be chosen, while for the switching or cover areas, a polymer with high elasticity or flexibility must be chosen. In other words, in multi-component injection-molding technology, two polymers with different flexibility must be chosen which must still be compatible to produce good adhesion at the borders.

The invention will now be explained in greater detail with reference to the enclosed figures.

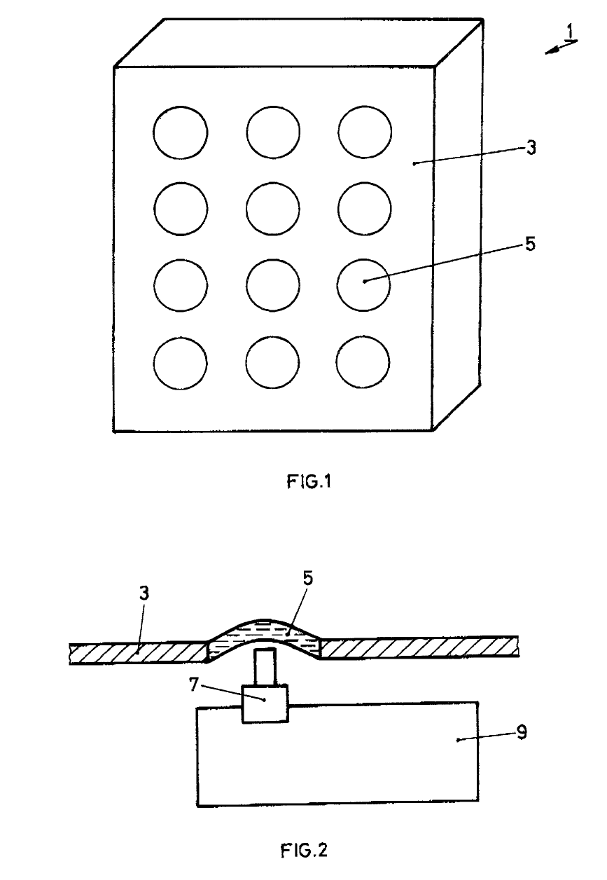

FIG. 1 is a schematic perspective view of a switch cover having flexible switch areas,

FIG. 2 is a cross section of a cutout from a hearing aid housing having a flexible switch area and

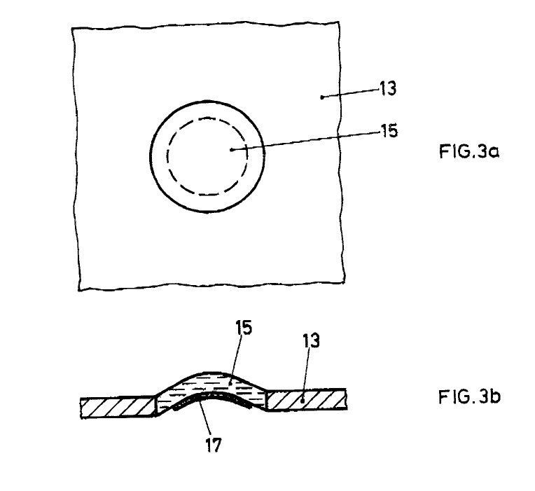

FIG. 3a and 3b show a top view and cross section of a cutout from a hearing aid housing with another variation of embodiment of a flexible switch area.

FIG. 1 shows a front top perspective view of a cover housing I for the waterproof and dirt-protected cover of switch elements, for example pressure switches, keys, touch pads, etc. The housing includes a dimensionally stable or relatively rigidly designed housing part I and flexible or elastic switch areas 5. It is essential to the invention that the housing part 3 and the switch areas 5 be produced at the same time in one production step, for example by so-called ZK-injection molding technology. The advantage of this process is that, especially with tiny housings and tiny covers, different areas can be made in terms of flexibility, without having to connect different materials, for example by means of mechanical or other joining technologies, like gluing, for example. This ZK or multicomponent injection-molding technology makes it possible to process different materials at the same time and hence to produce areas with different flexibility and elasticity. Now it is possible, by means of the housing or cover 1, to cover one or more switch elements so they are waterproof or safe from dirt, and these switch elements can still be activated by pressure or contact. It is also possible to make the flexible switch areas 5, for example, at least partly transparent, whereby the switch placed underneath, for example a button, is visible.

FIG. 2 shows a section of a specific example of embodiment of the cover housing in the invention; it is a cover housing of a waterproof hearing aid. The largely rigidly designed housing part 3 and the switch area 5, designed to be flexible or movable, can also be seen. A switch or key 7 is placed under the switch area 5 and can be activated by pressure on the switch area 5. Electronics 9 can be switched on by means of the switch or key 7.

Of course, the drawing in FIG. 2 is only an example, and the invention is especially suited for any kind of tiny housing covers in which switch elements placed in the housing must be activated by pressure and/or contact, whereby these switch elements are placed in the housing so they are waterproof and protected from dirt. No switch or key need be arranged under the switch area 5, as shown in FIG. 2, but it is entirely possible to make an area responsive to contact, since the moving switch area 5 can also easily be pressed in, and so contact can be made with a housing part of the electronics.

Finally, it is also conceivable, as shown in FIGS. 3a and 3b, to designed the flexible two-component housing part 15 so it is electrically conductive, so that a switch can be triggered only by contact on the electronics or a switch element. Here, it is possible to use either an electrically conductive polymer material to make the flexible housing part 15, for example a polymer containing an electrically conductive filler, or to coat the inside 17 of the flexible material with a conductive material. This can be either a metal membrane or an electrically conductive polymer. A polymer with a certain surface conductivity is enough to trigger a switch on contact with electronics or a switch element. FIG. 3a shows a top view of a switch area designed in this way, while FIG. 3b shows the corresponding switch area in cross section.

1. A device to cover one or more switch elements (7) that can be activated by pressure and/or by contact to prevent it from getting dirty or to prevent moisture from getting inside, etc., characterized by the fact that a cover (1) is composed of at least one housing part (3) and at least one cover area (5), whereby the cover (1) is available by means of ZK or multicomponent injection-molding and/or deep-drawing technology.

2. The device in claim 1, characterized by the fact that the cover area or areas is (are) arranged integrally in the housing part (3).

3. The device in one of claims 1 or 2, characterized by the fact that the cover area or areas (5) is (are) provided to be arranged over the switch element (7) to be activated.

4. The device in one of claims 1 to 3, characterized by the fact that the cover area or areas is (are) designed to be flexible and/or at least partly transparent.

5. The device in one of claims 1 to 4, characterized by the fact that the cover area or areas is (are) made of an elastic polymer, like an elastomer polymer, in particular.

6. The device in one of claims I to 5, characterized by the fact that the housing part (3) is made of a dimensionally stable, thermoplastic or partly crosslinked duroplastic polymer and the cover area or areas is (are) made of a flexible or elastic polymer.

7. The device in one of claims 1 to 6, characterized by the fact that the cover area is made of an elastomer polymer, like ethylene propylene rubber elastomers, polyamide elastomers, flour-rubber polymers, butyl rubber polymers, styrene-butadiene rubber polymers and/or SEBS (styrene-ethylene-butylene-styrene elastomers).

8. The device in one of claims 1 to 7, characterized by the fact that the cover area (15) is made of an electrically conductive polymer, especially like a polymer containing an electrically conductive filler, and/or that the cover area is coated on the inside with an electrically conductive material (17), like a metal membrane or an electrically conductive polymer.

9. A process for producing the device in one of claims 1 to 8, characterized by the fact that the cover, consisting of at least one housing part and at least one cover area, is produced by so-called ZK or multi-component injection-molding technology by processing at least two polymer materials with different flexibility by means of injection molding.

10. The process in claim 9, characterized by the fact that at least one thermoplastic or partly crosslinkable, thermoplastic polymer material and at least one partly flexible or elastic polymer material are processed at the same time by ZK or multi-component injection-molding technology.

11. The process in claim 10, characterized by the fact that it involves a so-called elastomer for the flexible or partly elastic polymer.

12. A hearing aid by means of a device in one of claims 1 to 8.

13. A conductive moving part of a switch housing to trigger a switching process having the device in claim 8.

14. The use of the process in one of claims 9 to 11 to produce a waterproof hearing aid.
